(19) United States
(12) Patent Application Publication
(10) Pub. No.: US 2003/0071990 A1
(43) Pub. Date: Apr. 17, 2003

(54) Multi dimensional dither technique for optical element alignment

(76) Inventors: Michael C. Stich, Rochester, MN (US); Arlen J. Bowen, Rochester, MN (US); Nathaniel C. Anderson, Pine Island, MN (US)

Correspondence Address: Jonar J. Tolentino, Dorsey & Whitney LLP, 220 South Sixth Street, Minneapolis, MN, 55402-1498, US

(21) Appl. No.: 10/134,986

(22) Filed: Apr. 29, 2002

Related U.S. Application Data
(60) Provisional application No. 60/287,463, filed on Apr. 30, 2001.

(51) Int. Cl. G01B 11/26

(52) U.S. Cl. 356/153; 356/399

(57) ABSTRACT

The subject invention uses a dither technique and a Discrete Fourier Transform to simultaneously align optical components along two axes orthogonal to the optic axis. The dither technique and the magnitude of the transmitted light are used to detect the misalignment in both directions simultaneously, and the Discrete Fourier Transform is used to detect the size and direction of the misalignment.

### CROSS-REFERENCE TO RELATED APPLICATION(S)

This application claims priority from provisional application No. 60/287,463 dated Apr. 30, 2001.

### FIELD OF THE INVENTION

The present invention relates to aligning optical elements. More specifically, the present invention relates to a method and apparatus for optical lelements using a dither technique.

### BACKGROUND OF THE INVENTION

Optical systems typically use optical components such as laser diodes, photodetectors, and optical fibers to detect, receive, or transmit optical signals. To minimize the loss on a transmitted signal and therefore the overall quality of the optical system, the optical components must be precisely aligned during assembly. However, since many of the optical components are relatively small, aligning such components can be a difficult and time consuming process. Consequently, measuring and correcting an alignment error quickly is an important step in reducing the time for the assembly or repair of an optical system.

One known method for aligning optical elements is the “hill climb” method. In this method, one optical element is moved, relative to an opposing optical element, along a linear path that is orthogonal to the optical axis. The optical axis is assumed to be the z-axis, with x and y being orthogonal to the optical axis (See FIG. 1). The magnitude of the light transmitted is monitored during the motion. (See, for example, “Application Note No. 6, Fiber to Waveguide Alignment Algorithm,” Newport Corp, DS-03002, by Kamran S. Mobarhan, Martin Hagenbuechle, and Randy Heyler.)

This method requires stepping slowly up the light intensity curve to detect whether the peak has passed and that it is not a local maximum, and then stepping backward across the peak again with a smaller step size to refine the peak location. This back and forth process is then repeated several times to refine the peak location. The entire process is then repeated in the orthogonal direction, because the alignment process must be performed in a two-dimensional plane. The original direction is then aligned one final time to ensure that there is no cross coupling in the alignment.

Another alignment method known as “dither,” applies a sinusoidal signal through one optical component as it is being moved relative to an opposing optical element. The signal is then measured across an opposing optical element and the resulting light amplitude variation is then used as a means of detecting the alignment. (See, for example, U.S. Pat. No. 5,450,508, “Apparatus and Method for Optical Fiber Alignment Using Adaptive Feedback Control Loop,” Casimer M. Decusatis, and Lawrence Jacobowitz, 1995.) In this method, a comparison is made of the transmitted light magnitude to determine if a second harmonic is present and if so, which half cycle it is on. The timing of the pulses generated when the magnitude crosses the detection level is used to determine direction of the component misalignment. This process is then repeated for the opposite orthogonal axis.

While the dither method is likely somewhat quicker than the hill climb method, it still requires repeating the motion in two separate orthogonal direction. Consequently, there is still a need in the art for a method of quickly and reliably aligning optical components such as laser diodes, photodetectors, or optical fibers.

### BRIEF SUMMARY OF THE INVENTION

The present invention satisfies the need in the industry for a method by which one can quickly and reliably align optical components such as laser diodes, photodetectors, or optical fibers. In particular, the method of the present invention improves the speed of optical component alignment by utilizing dither and the Discrete Fourier Transform DFT algorithm to simultaneously align optical components in two directions orthogonal to the optic axis. The method uses dither and the magnitude of the transmitted light to detect the size and direction of the misalignment in both axes simultaneously via the Discrete Fourier Transform (DFT).

In one embodiment of the subject invention, a first and second optical element are moved relative to one another in two directions simultaneously. With one optical element being moved generally sinusoidally relative to the x-axis and the second optical element being moved generally sinusoidally along the y-axis.

In one embodiment, a Piezoelectric motor adapted to receive an optical element is used to generate the sinusoidal motion of each optical element. A drive signal generator communicates with each motor and coordinates the movement of the motors. A position tracker is used to monitor the respective positions of the first and second optical element. The positional tracker communicates positional information to a central processor

In one embodiment, a light source sends an optical signal through the optical elements. This signal is then received by an optical sensor which measures the magnitude of the light. The magnitude of the light is then converted in a known manner and communicated to the central processor.

In one embodiment, the central processor includes computer code to perform a Fourier Transform from the data received from the optical sensor and the positional tracker.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of two optical elements with and their axes.

FIG. 2 is a perspective view of one embodiment of the subject invention.

FIG. 3 is a perspective view of an alternative embodiment of the subject invention.

FIG. 4 is the plot of the real part of the Fourier transform obtained as a function of the average offset between the parts to be aligned.

FIG. 5 is the plot of the imaginary part of the Fourier transform.

FIG. 6 is the plot of the of a Fourier transform wherein k=7.

FIG. 7 is the plot of a Discrete Fourier Transform Coefficients of a second harmonic of the dither frequency.

FIG. 8 a flow diagram of the operation of one embodiment of the subject invention.

### DETAILED DESCRIPTION

### General Overview

The subject invention is a method and a system for quickly and reliably aligning optical elements within an optical system. As can be appreciated by one skilled in the art, the subject invention is easily adaptable to align a number of different optical elements such as, but not limited to, laser diodes, photodetectors, or optical fibers.

In one embodiment, the subject invention uses a dither technique and a Discrete Fourier Transform to simultaneously align optical components along two axes orthogonal to the optic axis. The dither technique and the magnitude of the transmitted light are used to detect the misalignment in both axes simultaneously, and the Discrete Fourier Transform is used to detect the size and direction of the misalignment.

In one embodiment, the relative sinusoidal movement of the two optical elements causes the magnitude of the light to be modulated in a sinusoidal fashion. The position of the parts at every point in time is known, either through knowing the sinusoidal driving functions, or by measuring the position in the x and y directions with additional sensors. The magnitude of the light is measured for the required time based on noise considerations, and converted to digital form for processing in a computer.

A single frequency Fourier transform is then performed using one of the positions as the reference signal, e.g., a position along the x-axis, and the measured magnitude of the light passed between the parts as the signal to be transformed. The resulting real and imaginary parts of the Fourier transform, for example aₓ+jbₓ, is then used to detect the misalignment.

### Alignment System

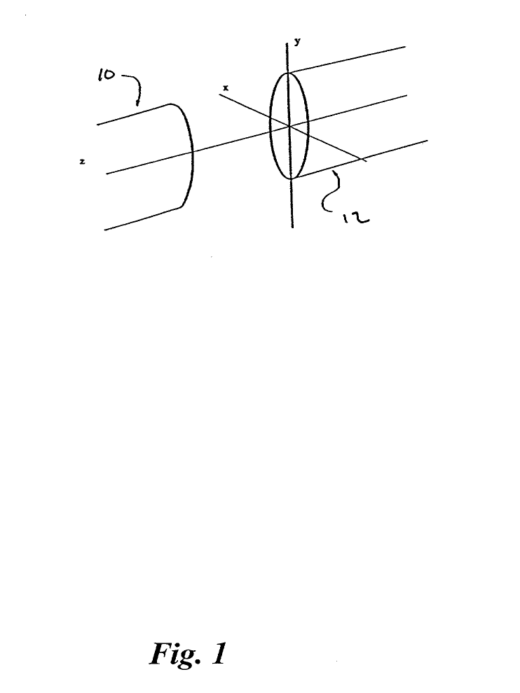

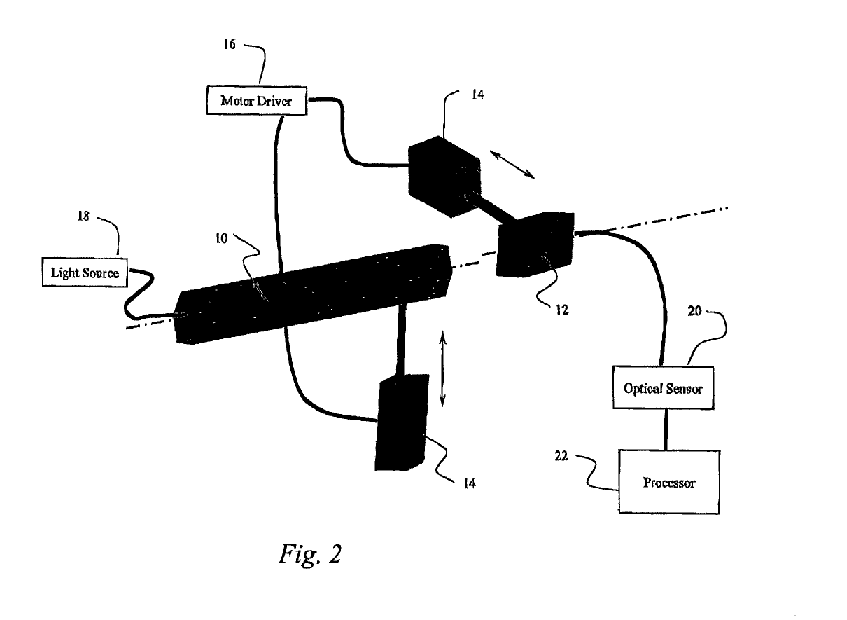

As shown in FIGS. 1, 2 and 3, in one embodiment of the subject invention, a first 10 and second 12 optical element are moved relative to one another in two directions simultaneously. With one optical element being moved generally sinusoidally relative to the x-axis and the second optical element being moved generally sinusoidally along the y-axis. The optical elements can interchange their axes of motion without affecting the results of the alignment system.

The optical elements can be moved by one of several standard hardware applications that are well known in the industry. In one embodiment, a Piezoelectric motor 14 is used to generate the sinusoidal motion, and the optical element is coupled to its respective motor 14 in a known manner. A drive signal generator 16 communicates with each motor and coordinates the movement of the motors. Preferably, the optical elements move at the same frequency. The drive signal 16 also generates a phase lag of 90° between the motors.

A position tracker is used to monitor the respective positions of the first 10 and second 12 optical element. The position of the optical elements at every point in time is known, either through knowing the sinusoidal driving functions of the drive signal generator 16, or by measuring the position of the optical elements in the x and y directions with positional sensors (not shown).

In one embodiment, a light source 18 sends an optical signal through the optical elements. This signal is then received by an optical sensor 20 which measures the magnitude of the light. The magnitude of the light is then converted in a known manner and communicated to a central processor 22.

The central processor 22 can be any computer known to those skilled in the art, including standard attachments and components thereof (e.g., a disk drive, hard drive, CD/DVD player or network server that communicates with a CPU and main memory, a sound board, a keyboard and mouse, and a monitor). The processor of the CPU in the computer may be any conventional general-purpose single- or multi-chip microprocessor. In addition, the processor may be any conventional special purpose processor such as a digital signal processor or a graphics processor. The microprocessor can include conventional address lines, conventional data lines, and one or more conventional control lines.

In one embodiment, the central processor 22 also communicates with the drive signal generator 16, and a plurality of position sensors in order to receive positional information on the optical elements. The central processor 22 also includes therein computer code to perform a Fourier Transform from the data received from the optical sensor 20, signal generator and the position sensors.

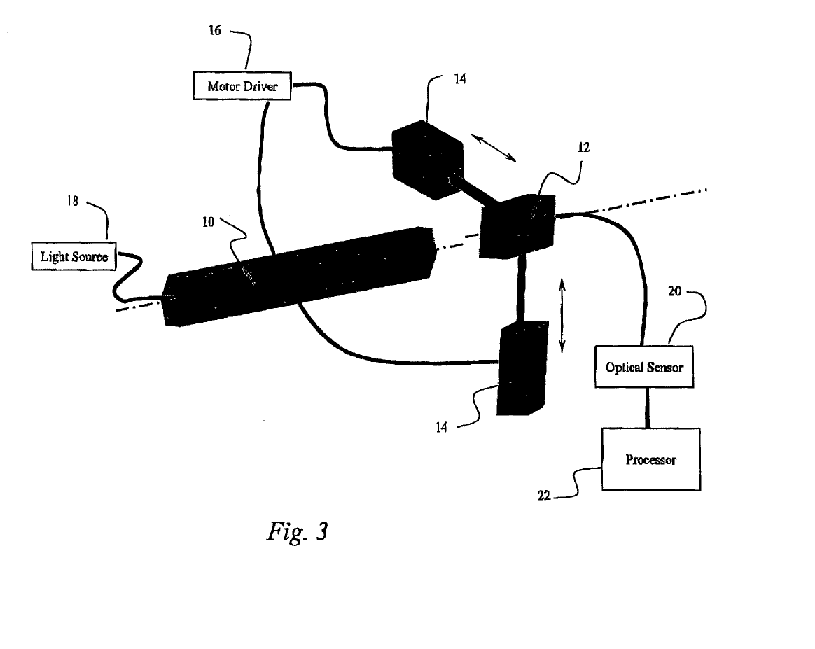

As shown in FIG. 3, in one embodiment, the same effect can be produced by moving a single optical element sinusoidally along both orthogonal axes while one element remains in a fixed position. This is accomplished by coupling one optical element to a pair of motors, with each motor positioned to generate a sinusoidal movement along one orthogonal axes. One skilled in the art may also appreciate that a single motor capable of producing a sinusoidal movement along both axes orthogonal to the optic axis may also be used.

### Calculations

The movement of the motors 14 results in a relative circular motion of the optical elements relative to the other. This circular motion, or dither, is superimposed on the static misalignment, herein called the offset. The static misalignment results from the initial placement of the parts. If the intensity pattern in the x-y plane is known to be an ellipse, the motion could also be modified to form an ellipse with the same major and minor axes as the known pattern.

Because the motion covers the x-y plane simultaneously, the initial motion will not miss the area of at least partial light transmission if it is within the range of motion. This is a significant improvement over a linear scan method such as the hill climb method. If the offset is large on one axis and the initial direction of motion is chosen so that it bypasses the desired area, the linear scan methods could possibly fail to find the area of transmission initially, even if it is within the range of motion of the optical elements. In such a case, the linear scan methods would likely then require additional steps to be able to start the alignment.

In order to minimize the time it takes the subject invention to perform an alignment procedure, it is preferable to use the highest possible frequency consistent with the particular hardware implementation. Different frequencies could be used to move each element in its respective axis; however, it is preferable that the same high frequency be used for both axes.

The magnitude of the light traveling through the optical elements will be modulated in a sinusoidal fashion as the two optical elements pass in and out of alignment with the circular motion. The position of the parts at every point in time is known, either through knowing the sinusoidal driving functions, or by measuring the position in the x and y directions with additional sensors. The magnitude of the light is measured for the required time based on noise considerations, and converted to digital form and communicated to the central processor 22.

The processor 22 performs a single frequency Fourier transform using one of the positions as the reference signal, e.g., a position along the x-axis, and the measured magnitude of the light passed between the parts as the signal to be transformed. The resulting real and imaginary parts of the Fourier transform, for example aₓ+jbₓ, can be used to detect the misalignment.

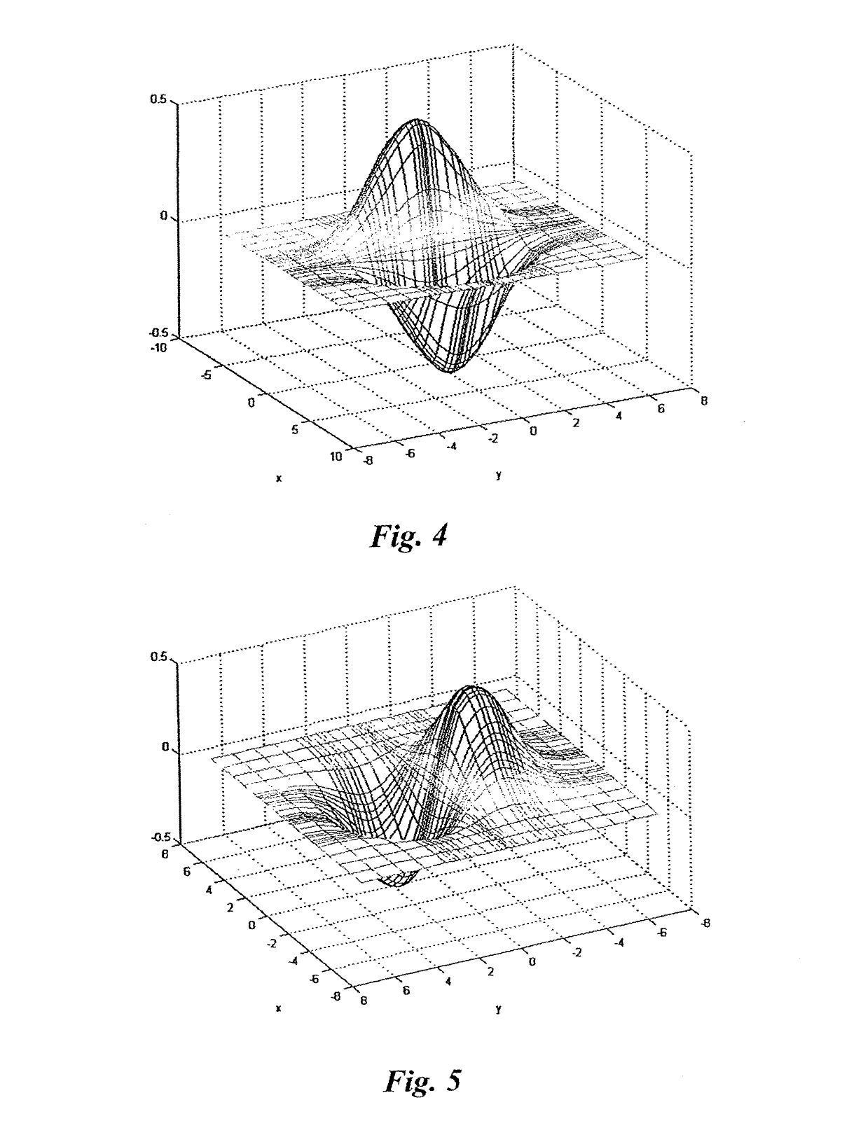

FIG. 4 is the plot of the real part of the Fourier transform obtained as described above as a function of the average offset between the parts to be aligned. The scale is arbitrary. In the central region it is approximately a linear function of the misalignment along the x-axis. This result can thus be used to determine the direction and size of the motion required to align the components along the x-axis.

If the initial misalignment is too large the signal may disappear, and no information is obtained. This is shown at the edges of FIG. 4 where aₓ=0. Increasing the size of the sinusoidal dither signal can compensate for this. At some point the signal will reach a practical maximum, and an initial search may have to be performed to reach a practical range. The system can be designed to reduce or eliminate the need for this by increasing the available dynamic range for the dither.

FIG. 5 is a plot of the imaginary part of the Fourier transform. Note that its linear region provides adjustment information in the y direction in a similar fashion to the real part described above. Both of these results are obtained from the processing of a single measurement at each offset location. Thus the alignment of both the x and y axes is made simultaneously.

Since the x and y alignment signals have a peak and then fall off when the offset increases beyond that peak, it is not possible from that information alone to determine which side of the hump the offset is on. We can apply second harmonic information to do this. Using the same light magnitude information that was obtained above, the method of the present invention calculates the Fourier transform relative to the x-dither signal at twice the dither frequency. This provides the real and imaginary parts of the second harmonic, for example cₓ+jdₓ.

For a particular system, a calibration factor “k” can be determined relating the ratio of the magnitudes of the first and second harmonics. Thus the following equation can be used to determine when the alignment is inside or outside the peak:

(aₓ²+jbₓ²)>k(cₓ²+jdₓ²)

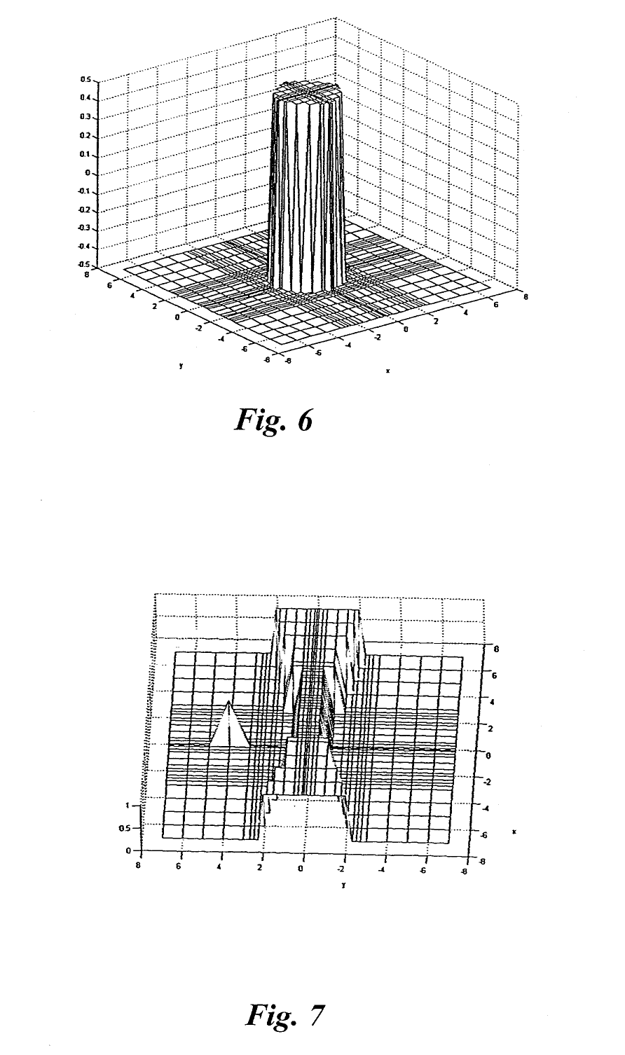

If this inequality is true, then the average offset is within the region where the coefficients are approximately linear. If it is false, then one or both offsets are outside that region. A simulation of this function results in the plot shown in FIG. 6, with a k=7 for this particular situation. The value for “k” is determined by measuring the aₓ, bₓ, cₓ, and dₓ coefficients for a variety of offsets and finding a value that matches the first and second harmonic ratios at the peak.

This process, however, does not indicate if the x, y, or both directions are outside the linear range. The direction required to reduce the offset is known because the sign of the coefficient does not change for a given direction of offset. Only the distance is uncertain. There are several ways to deal with this situation, three of which are outlined below.

First, moving toward the center by an amount calculated assuming the offset is in the linear range will cause the offset to be reduced. The dither measurement is then repeated and if the associated coefficient increases, it is known that the original measurement was well outside of the peak. If it decreases but does not go to zero, then it was slightly outside the peak and is now in the linear range. If it goes to zero, the original assumption of being inside the linear range was correct. If necessary another offset correction can be applied using this information to determine the current offset and therefore how far to move.

Another method is to increase the magnitude of the dither signals (the resulting light signal which has passed between the optical elements) by increasing the magnitude of the light signal from the light source 18. This will increase the size of the range that is monotonic with offset. However, the shape of the light transmittance function as the x and y positions vary may cause nonlinear response near zero offset. A large area with constant magnitude or a response function that very quickly transitions from maximum to zero response can cause a flat spot in the coefficient, as opposed to an offset function near zero offset. Adjusting the dither magnitude and possibly the z-axis separation can help optimize the system. In this case the linear range may be sufficient to cover all alignment cases. Alternatively, a coarse and fine alignment could be performed with two different dither magnitudes and/or z-axis separations.

A third method is to calculate a function based on the DFT coefficients of the second harmonic of the dither frequency. For example, the function aₓ²>4cₓ² is plotted in FIG. 7 with a z value of 1 indicating true, and 0 indicating false. The “4” in the equation is again a calibration factor. The coefficient cₓ is the real part of the DFT of the second harmonic of the measured magnitude response signal during dithering.

This function can be used to approximately determine when the y offset is outside the linear region. (There is a similar function for the x offset, bₓ²>4cₓ² and all comments apply equally to it with appropriate adjustments for x versus y.) The above function is not completely independent of x as would be ideal for determining the y offset, but if the previous circular function is first used to determine that the offset is definitely outside a circular region near the origin, the dependence on x can be reduced. There are also undesired values of this function along the x=0 offset indicating the y is actually inside the linear region when it is not. In practice these situations are not likely to arise, as they appear to require an offset of exactly 0, which is possible in the simulation but unlikely when there is noise and other disturbances on the measured signal.

### Operation

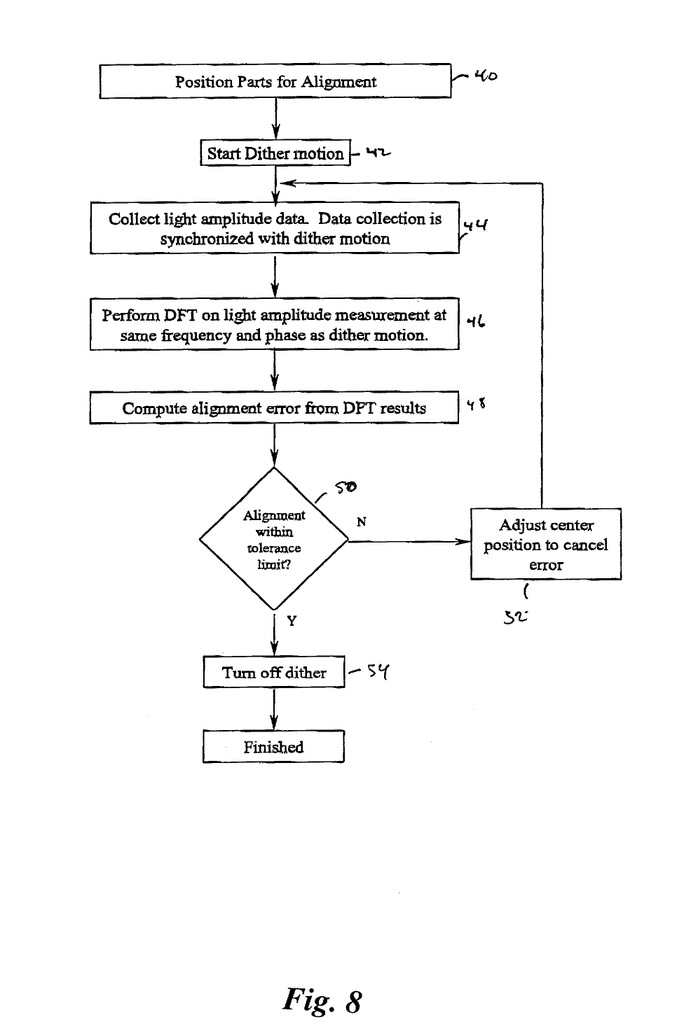

FIG. 8 shows the operational steps of one embodiment of the subject system. One would first align the optical elements 40 using either plain sight or through a mechanical guide. A dither motion is then generated 42 by activating the motor 14. The optical sensor 20 works in cooperation with the processor 22 to collect light amplitude data 44 while the optical elements 12, 14 are dithered. The data collection 44 is synchronized with the dither motion.

A Discrete Fourier Transform is then performed on the light amplitude data using the same frequency and phase as the dither motion 46. The resulting imaginary and real parts of the Discrete Fourier Transform is then used to detect the alignment error 48. A determination is then made on whether the alignment is within the tolerance limit 50. If the alignment error is within the tolerance limit, there is no need to realign. However, if the alignment error is greater than the tolerance limit 52, the optical elements are adjusted to cancel the error, and the process is repeated to verify that the adjustment puts the optical elements within tolerance limits.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims. Any numbering or ordering of elements in the following claims is merely for convenience and is not intended to suggest that the ordering of the elements of the claims has any particular significance other than that otherwise expressed by the language of the claim.

We claim:

1. A method of aligning a first and second optical element comprising:
transmitting a light through the first and second optical element;
moving the first optical element;
measuring the magnitude of detected light; and
applying a Fourier transform on the magnitude of the measured light.

2. The method of claim 1, wherein the first optical element is moved in a circular motion relative to the second optical element.

3. The method of claim 1, and further comprising tracking the position of the first optical element.

4. The method of claim 1, wherein the first optical element is moved in a generally sinusoidal motion.

5. The method of claim 4, and further comprising the step of moving the second optical element in a generally sinusoidal motion, and wherein there is a 90° phase lag between the sinusoidal motion of the first and second optical element.

6. The method of claim 4, wherein the first optical element is moved in an elliptical pattern.

7. The method of claim 1, wherein a Discrete Fourier Transform is applied to determine the magnitude and direction of the misalignment between the first and second optical elements.

8. The method of claim 7, and further comprising correcting the positioning of the first and second optical elements based on the result of the Discrete Fourier Transform.

9. A system for aligning optical elements comprising:
a light source;
a first motor adapted for receiving an optical element, the first motor configured to produce a sinusoidal motion; and
an optic sensor.

10. The system of claim 9, and further comprising a processor in communication with the optic sensor.

11. The system of claim 9, and further comprising a signal generator in communication with the first motor.

12. The system of claim 9, and further comprising a second motor adapted to receive an optical element, wherein the first and second motors are each configured to produce a sinusoidal motion.

13. The system of claim 12, wherein the first and second motors are each coupled to separate optical elements.

14. The system of claim 9, and further comprising a position tracker for monitoring the position of each optical element.

15. The system of claim 14, wherein the position tracker includes a plurality of position sensors.

16. The system of claim 14, wherein the position tracker is coupled to a signal generator.

17. A method of aligning optical elements comprising transmitting a signal through a first and second optical element;
first and second optical element;
measuring the magnitude of the signal; and
performing a Discrete Fourier Transformation on the signal.

18. The method of claim 17, and further comprising moving one of either first or second element in an elliptical path.

19. The method of claim 17, and further comprising moving one of either first or second element in a circular path.

20. The method of claim 17, and further comprising moving the first and second optical element sinusoidally with a 90° phase difference in their respective motions.
